(19) United States
(12) Patent Application Publication
(10) Pub. No.: US 2006/0206351 A1
(43) Pub. Date: Sep. 14, 2006

(54) Registered traveler systems and methods

(75) Inventors: Michael Hodges, Omaha, NE (US); Roger Musfeldt, Omaha, NE (US); Don Alvarado, Littleton, CO (US); Curt Beeson, Omaha, NE (US); Todd Nuzum, Omaha, NE (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO (US)

(21) Appl. No.: 11/367,862

(22) Filed: Mar. 3, 2006

Related U.S. Application Data
(60) Provisional application No. 60/660,533, filed on Mar. 9, 2005.

(51) Int. Cl. G06Q 99/00

(52) U.S. Cl. 705/1; 705/5

(57) ABSTRACT

The present invention provides systems and methods for registering frequent travelers and for confirming traveler identities so that a more streamlined procedure may be used during security checks prior to departure of the registered traveler. One such method includes receiving a customer data set and a customer biometric with a controller, and transmitting at least a portion of the data set to a remote system. In some embodiments the remote system is a background check system, such as an FBI database system for checking whether the individual associated with the biometric is wanted by local, state or federal authorities, is on a terrorist watchlist, and the like. The method includes receiving a response from the remote system, and creating a registered traveler record using the customer data set and the customer biometric. In this manner, a customer can become a registered traveler, after providing various data and biometric(s), and submitting to a background check.

### CROSS REFERENCE TO RELATED APPLICATIONS

This application claims the benefit of U.S. Provisional Application No. 60/660,533 filed on Mar. 9, 2005, the complete disclosure of which is herein incorporated by reference.

### BACKGROUND OF THE INVENTION

The present invention is related to improved security for airlines and other modes of transportation and, more specifically, to systems and methods for registering frequent travelers so that a more streamlined procedure may be used during security checks prior to departure of the registered traveler.

Subsequent to the terrorist incidents on Sep. 11, 2001, local, state and federal authorities have instituted various security improvements intended to maintain the safety of the nation as a whole and, in specific cases, the safety of airline and other passengers traveling throughout the United States. For example, with respect to airline travel, the U.S. Department of Transportation formed the Transportation Security Administration (TSA) to perform security checks of passengers prior to departure on commercial airline flights in the United States. Numerous security procedures were instituted, including increased luggage inspections, passenger searches and inspections, identification checks, and the like. The federal government further passed the U.S. Patriot Act, which added additional security features affecting, among other things, travel throughout the United States.

While arguably providing increased security for airline and other travelers, one by-product of the increased security is longer lines and lengthier delays at airports and other security checkpoints. Thus, it would be desirable to have improved security systems and/or methods which allow at least some passengers to pass more quickly through airports or other transportation nodes, while insuring the safety of all passengers.

### BRIEF SUMMARY OF THE INVENTION

The present invention is related to improved security for airlines and other modes of transportation and, more specifically, to systems and methods for registering frequent travelers so that a more streamlined procedure may be used during security checks prior to departure of the registered traveler.

The present invention provides methods of registering travelers, such as airline passengers who desire to pass more quickly through airport security lines without sacrificing security. One such method includes receiving a customer data set and a customer biometric with a controller, and transmitting at least a portion of the data set to a remote system. The controller may include, without limitation, a processor, a server, or the like having computing functionality. The processor may be coupled to a memory having appropriate software for performing the desired functions. In some embodiments the remote system is a background check system, such as an FBI database system for checking whether the individual associated with the biometric is wanted by local, state or federal authorities, is on a terrorist watchlist, and the like. The method includes receiving a response from the remote system, and creating a registered traveler record using the customer data set and the customer biometric. In this manner, a customer can become a registered traveler, after providing various data and biometric(s), and submitting to a background check. In some aspects, the registered traveler record includes a registered traveler identifier. The identifier may be a string of alphanumeric characters, or may be an identifier embodied in a bar code, a magnetic stripe, a radio frequency identification device (RFID), or the like.

In some aspects, the customer data set includes at least a customer name, a customer address, and a customer identification number. The customer identification number may be a social security number, a drivers license number, an employee number, an immigration number, or the like. In some aspects, the customer data set includes a frequent flyer number associated with the customer, and/or a payment record. The payment record may include bank account information, credit card information, or the like. In this manner, enrollment fees may be charged to the customer for the customer's participation in the registered traveler program.

In some aspects, the customer biometric includes an iris scan. The iris scan may be of one eye or both eyes in alternative embodiments. In another aspect, the customer biometric includes at least one image of a customer face. For example, the biometric may include one or more digital images of the customer's face, such as a front-on view, a right side profile, a left side profile, and the like. In still other aspects, the biometric includes a customer fingerprint set. The fingerprint set may be of a single finger or thumb, or multiple digits. In a particular aspect, the customer fingerprint set includes a ten (10) print set.

The present invention further provides methods for confirming the identity of a traveler. In some instances, these methods will be particularly useful at airports, railroad stations, and other points of departure for customers, travelers, and the like. One such method includes creating a registered traveler record for a traveler, and storing the record in a database. The registered traveler record includes a registered traveler identifier and a registered traveler biometric. The method includes receiving a verification request from a remote computer-based system, with the verification request including a traveler identifier and a received biometric. The registered traveler record is retrieved, and the received biometric is compared to the registered traveler biometric. An authorization is returned if the received biometric matches the registered traveler biometric. In this manner, an individual traveling through, for example, an airport can provide the airport security with a biometric and a traveler identifier. The airport security or related system then transmits this information to a system maintaining the registered traveler records for verification that the individual at the airport is indeed a registered traveler. One benefit to the traveler would be the use of a registered traveler security line which is arguably shorter and thus faster than the standard security lines.

In some aspects, the database includes a plurality of registered traveler records for a plurality of registered travelers. In some aspects, the received traveler identifier is used to retrieve the registered traveler record. In this manner, the system can do a one-to-one match of the identifiers to retrieve the appropriate registered traveler record. As previously noted, the present invention will be particularly useful for airline travelers. Thus, in some aspects, the remote computer-based system includes an airport security system, an airline reservation system, or the like. In some aspects, receiving the verification request includes receiving an ISO 8583 formatted message. Further, the received traveler identifier may be compared to a watch list.

The registered traveler biometric may be a variety of biometrics within the scope of the present invention, provided the biometric is capable of distinguishing a particular individual. Preferably, the biometric is unique to the individual. In a particular aspect, the registered biometric and the received biometric both include a fingerprint. In other aspects, the registered biometric includes a fingerprint and the received biometric includes at least a portion of a fingerprint. In still other aspects, the registered traveler biometric includes a traveler iris scan, and the received biometric includes an iris scan. In other aspects, a controller coupled to the database compares the received biometric and the registered traveler biometric.

In some aspects, the method includes returning a message if the received biometric does not match the registered traveler biometric. In some aspects, the message includes a rejection notice. This may occur, for example, when the received biometric does not match the registered biometric, but the received biometric does not indicate the customer or traveler is a security threat. In other aspects, the message includes a detention notice. This may occur, for example, when either the received biometric does not match the registered biometric, and/or the received biometric is for an individual wanted by local, state or federal authorities, or on a watch list.

The present invention further provides traveler registration systems. One such system includes a controller coupled to a database having a plurality of registered traveler records, with each record including an identifier and a biometric. The controller is adapted to receive a traveler verification request from a remote requester, with the verification request including a received identifier and a received biometric. The controller further is adapted to retrieve one of the registered traveler records based at least in part on the received identifier, compare the biometric with the received biometric, and return a message to the remote requester, with the message having a result of the biometric comparison.

In some aspects, the remote requester is a computer-based airport security system, an airline reservation system, or the like. In other aspects, the system further includes an interface between the controller and a remote network, with the remote network adapted to perform a background check on the biometric.

Other objects, features and advantages of the present invention will become more fully apparent from the following detailed description, the appended claims and the accompanying drawings.

### BRIEF DESCRIPTION OF THE DRAWINGS

FIG. 1A is a simplified flow chart of a method for registering travelers according to the present invention;

FIG. 1B comprises a list of registered traveler data involved for use with some embodiments of the present invention;

FIGS. 2A-2F schematically depict alternative overall systems and methods of the present invention;

FIG. 3 is a schematic of a system of the present invention;

FIG. 4 is a simplified schematic of a system of the present invention; and

FIG. 5 schematically depicts the ability of various users to perform portions of methods of the present invention.

### DETAILED DESCRIPTION OF THE INVENTION

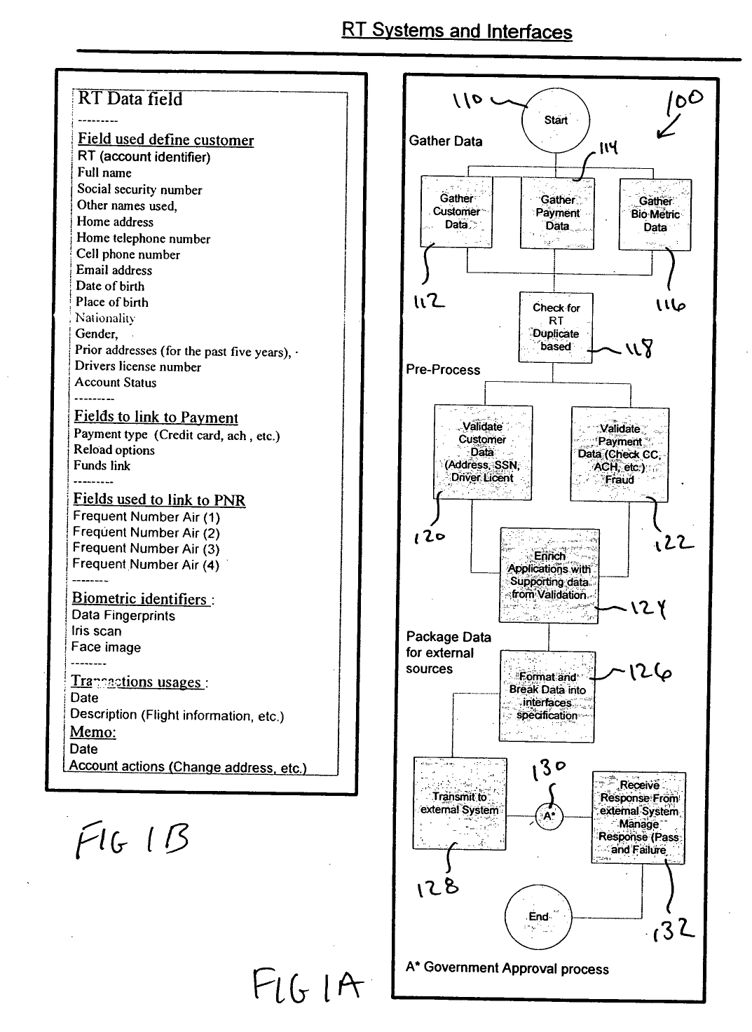

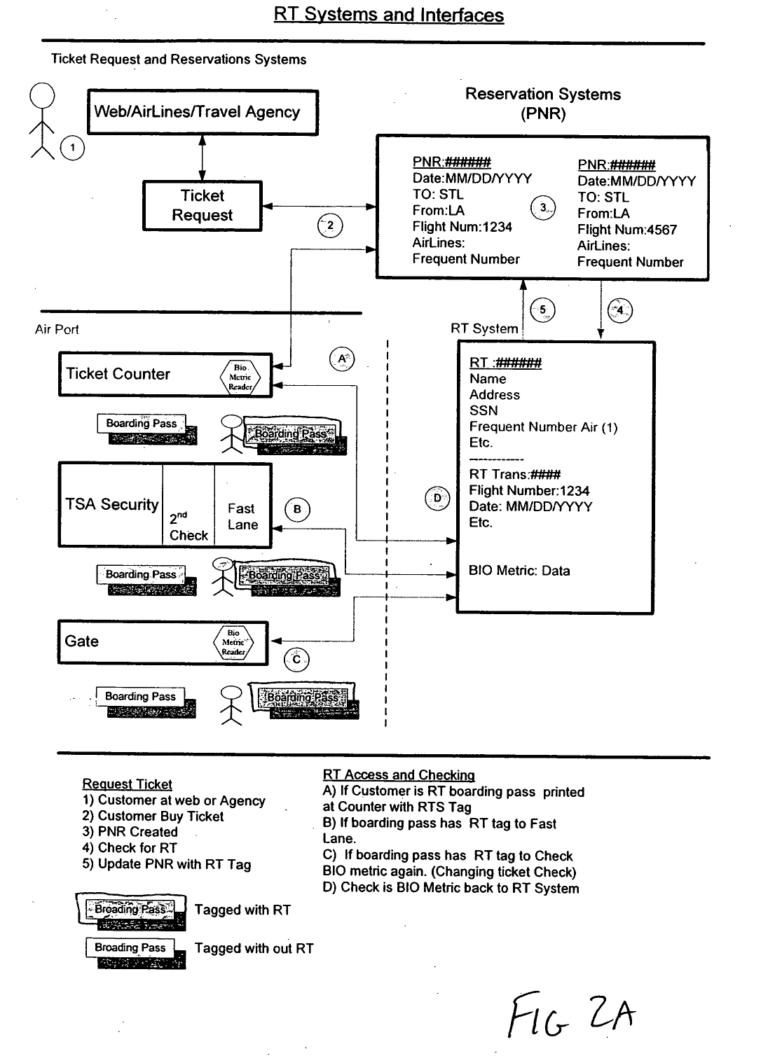

With reference to FIGS. 1-5, exemplary systems and methods of the present invention will be described. While the below examples involve airline passengers passing through airports using U.S. and foreign airlines, it will be appreciated by those skilled in the art that the systems and methods are further extendible to other means of transportation. For example, security systems implemented for rail passenger travel may be similar to or the same as those described herein for airline travel. In general, some embodiments of the systems and methods of the present invention involve registration of frequent travelers prior to their departure. More specifically, passengers pre-register to become a “registered traveler” by providing detailed personal information including, in some embodiments, passenger biometrics. This information is collected, and a background check is performed on the individual. The background check may include, for example, a check performed by the Federal Bureau of Investigations (FBI), the local police force, or other local, state or federal agencies. The check may include searches in various police or agency databases to determine if the individual has a criminal record, has any outstanding warrants, or the like. The individual may further be checked against various terrorist watch lists or databases maintained by the Central Intelligence Agency (CIA), the FBI, the Department of Homeland Security (DHS), and other agencies tasked to ensure the safety of U.S. citizens and property.

As shown in FIG. 1A, a method 100 for enrolling as a frequent traveler will be described. In method 100, the customer who wishes to register as a frequent traveler proceeds to an enrollment station to start the registration process (110). The enrollment station may include, for example, United States Postal Service (USPS) stations or offices located throughout the nation, including at various airports. Enrollment stations may also include police stations, fire stations, Secretary of State offices, Department of Motor Vehicle (DMV) offices, and other governmental office adapted to receive the necessary customer data as further described in FIG. 1B. Method 100 includes gathering the customer data (112), gathering customer payment data (114), and gathering customer biometric data (116).

The customer data may include, without limitation, the customer name, social security number, aliases or other names used, home address, telephone numbers, cell phone numbers, e-mail address(es), date and place of birth, nationality, gender, prior addresses for a prescribed period (e.g., five years), driver's license number, employment information, student information or number (if applicable), immigration identification (if applicable) and the like. In one embodiment, the customer provides the information in written form, such as on a registered traveler request form. In other embodiments, a customer service representative (CSR) takes the information from the customer. The CSR also may review the customer information sources, such as by looking at or photo-copying the customers birth certificate, drivers license, social security card, or other identification. In still other embodiments, a voice recognition system (VRS) is used to collect the information from the customer.

In some embodiments, the payment data gathered includes one or more of credit card information, checking or savings account information, and the like. Payment data may be gathered as part of the process for verifying the customer deserves registered traveler status. Payment data also may be collected and used for charging fees associated with being a registered traveler, and the like. In one embodiment, the registered traveler pays an initiation fee for the privilege of being a registered traveler. In other embodiments, the registered traveler pays periodic fees (e.g., monthly, quarterly, annually, or the like) for the privilege of being a registered traveler. In other embodiments, the registered traveler pays a trip fee, which may be applied for each trip taken by the registered traveler, for each leg of a trip taken by the registered traveler, or the like.

As noted in FIG. 1A, biometric data is gathered from the customer at the enrollment station. The biometric data may include, without limitation, one or more face images, an iris scan, fingerprint information, and a voice print or recording. The face image may be as simple as a digital photograph or image taken of the customer who has presented their personal information. This may include one or more pictures such as a front view, full face photo, a left side profile, a right side profile, and the like. The iris scan may be of one eye, or both eyes. The fingerprint information may comprise a single finger or thumb print, prints of multiple digits, or prints of all ten (10) digits. In a particular embodiment, the customer fingerprint set includes a ten print finger biometric in FBI format. The collection of biometric data may involve the use of fingerprint pads, optical imaging equipment, digital cameras, and a host of other biometric collection equipment known to those skilled in the art.

Once the customer information is collected, an optional check may be made of the existing registered traveler database to determine if a duplicate record currently exists (118). Method 100 then includes preprocessing of collected data, which may include validating the customer data, (e.g., the customer's address, social security number, driver's license number, etc.) with local databases containing such information (120). Payment records also may be validated by interfacing with known credit card databases, credit reporting systems, and the like (122). This initial validation may be useful, for example, in determining if check fraud or other crimes of deceit have been perpetrated against or by the customer. The customer records are updated accordingly, which may include enriching the data set collected with supporting data obtained from the validation steps (124). This data is then formatted (126) and transmitted to an external system for a background check (128).

The background check may include, without limitation, an FBI background check, a criminal investigation, or the like (130). The registered traveler system receives a response from the background check. In some embodiments, the response indicates whether the customer has been approved or denied registered traveler status (132). In other embodiments, the response indicates whether the customer may be approved or denied registered traveler status, subject to the collection of additional information or clarification of received data. If the requesting customer has been denied registered traveler status, the customer may be so notified. Further, depending on the reason the customer was denied registered traveler status, other appropriate action may be taken. For example, outstanding warrants may be executed, or the like.

Assuming the customer has been approved for registered traveler status, the customer is so notified. In one embodiment, the customer receives a pin mailer which the customer then uses to obtain a frequent traveler card or identifier. For example, the customer may be return to an enrollment station, such as a USPS office, and present their pin to complete the registered traveler procedure. At this point, the customer also provides biometric information which is matched to the pin assigned the customer to confirm that the customer is indeed the same individual who has been approved registered traveler status. In one embodiment, the enrollee receives a registered traveler card having desired information. In some embodiments, the registered traveler card issued to the registered traveler includes some or all of the following information and may include additional information: registered traveler name, a picture or image, one or more finger or thumbprints, an address, and a registered traveler number or identifier. Some or all of this information may be encoded in a bar code, a magnetic strip, or may be printed or imaged onto the registered traveler card. In some embodiments, the registered traveler card is used by the customer when purchasing tickets for travel, when obtaining a boarding pass, or the like.

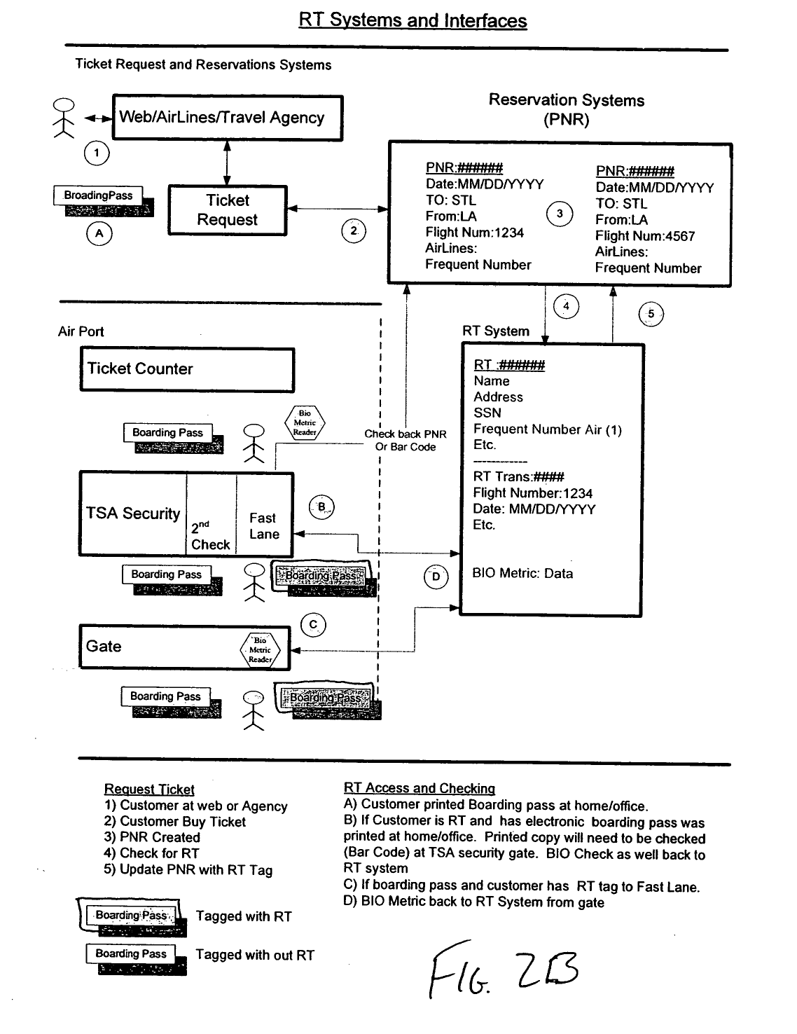

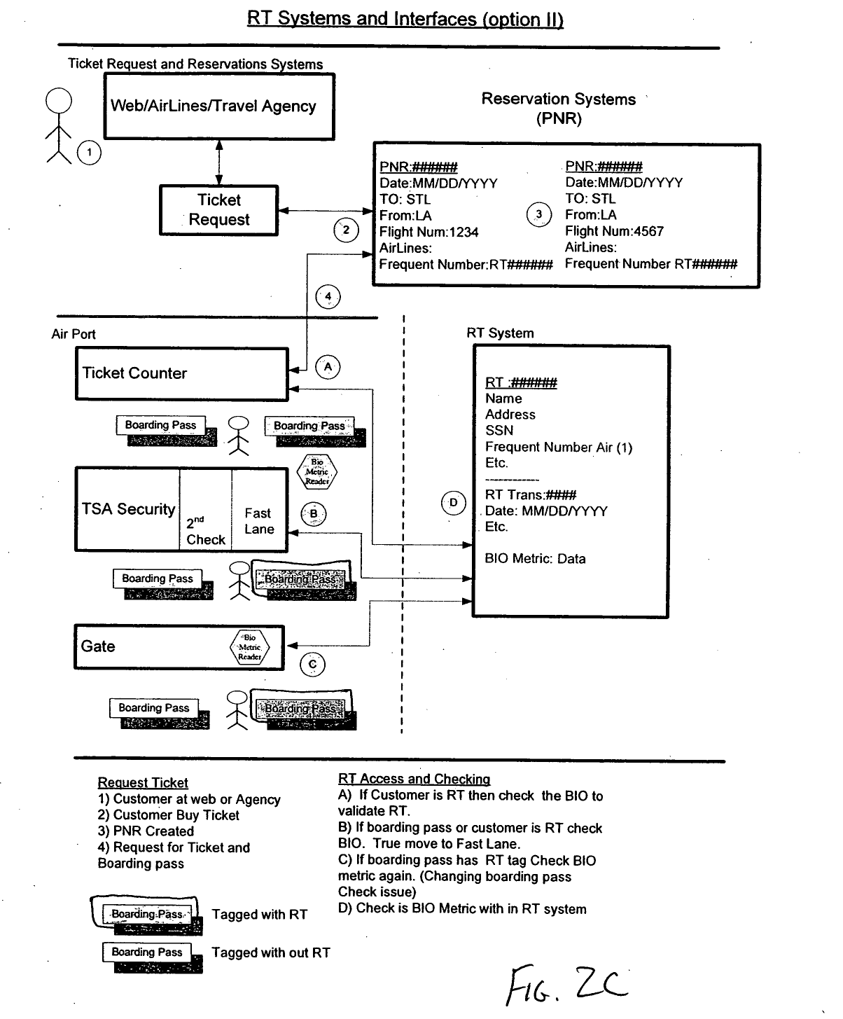

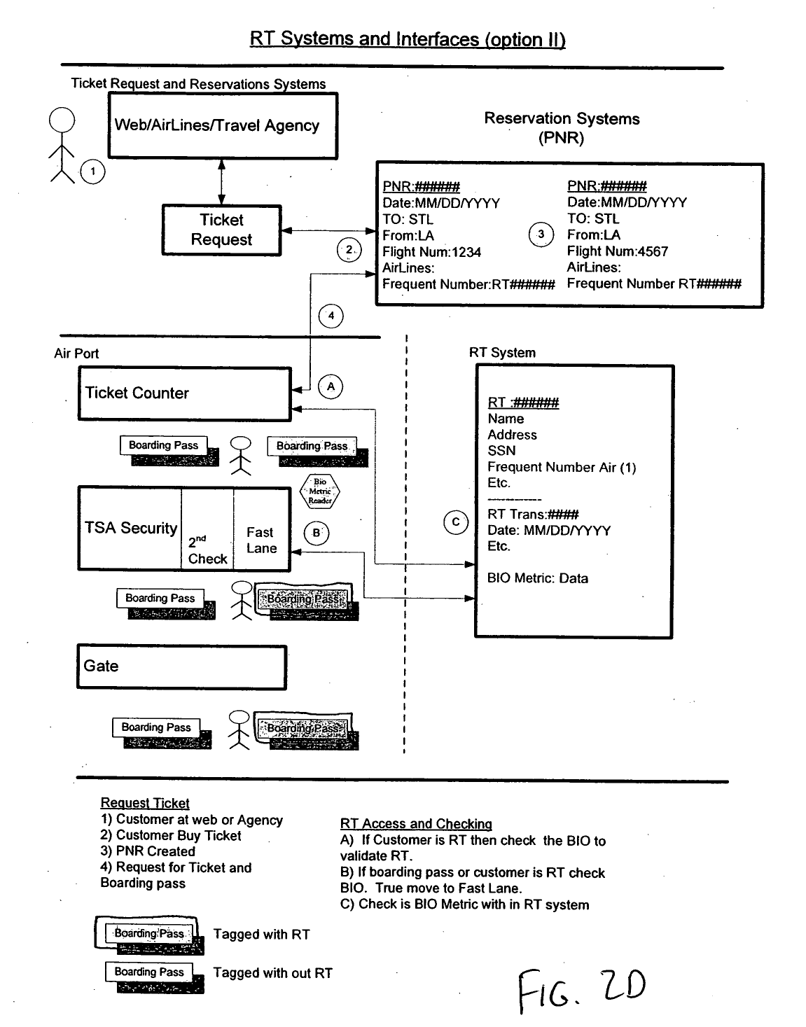

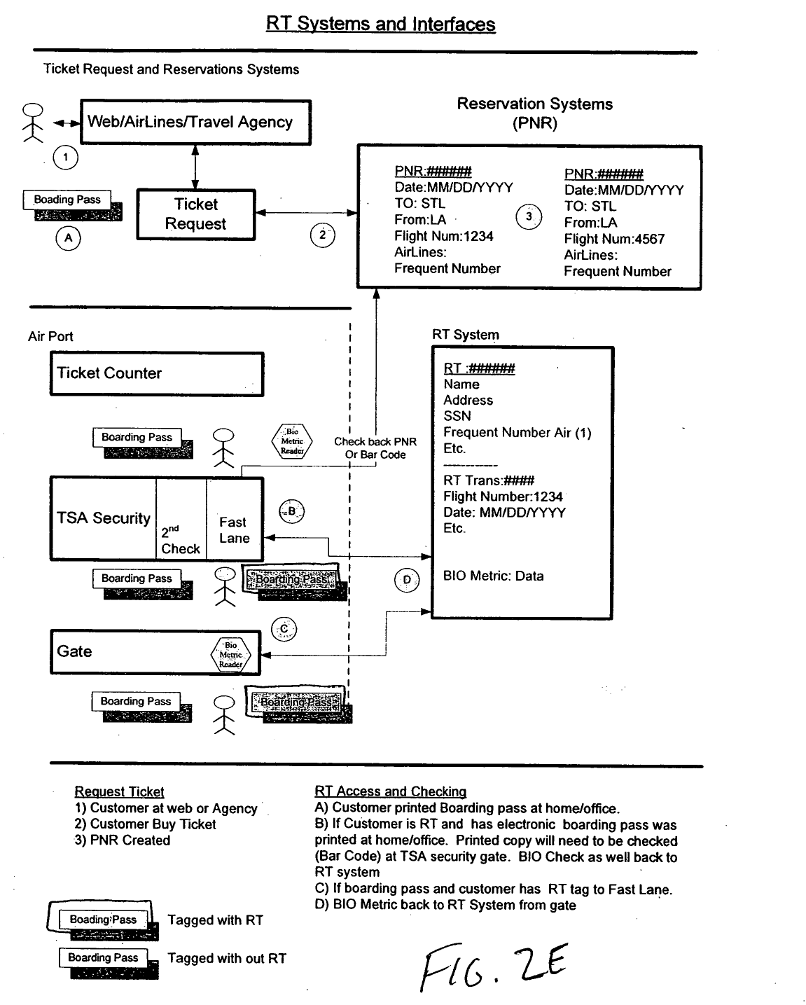

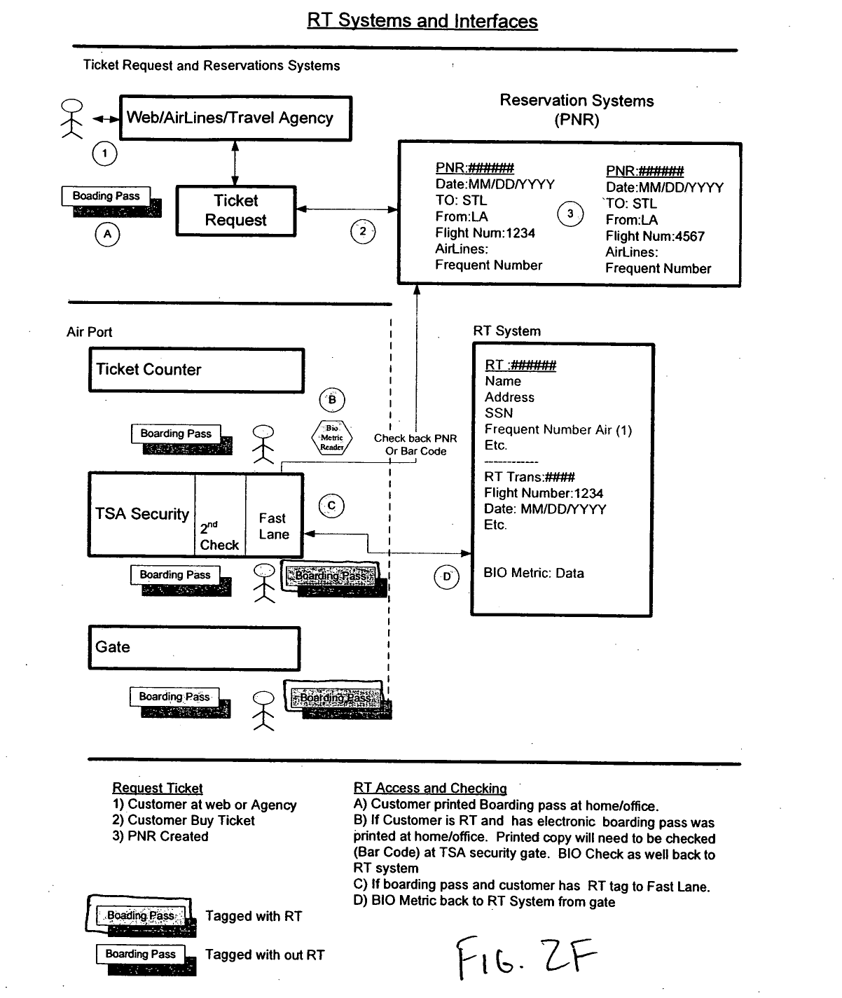

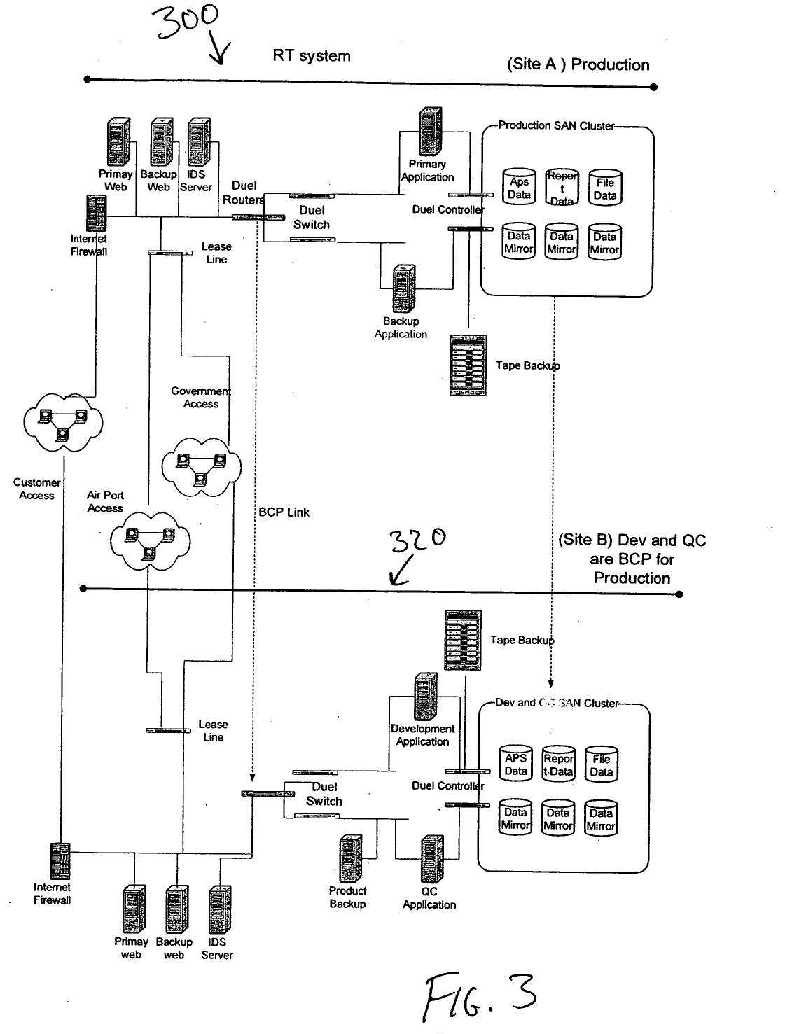

As shown in FIG. 1B, the registered traveler record is preferably stored in a registered traveler database. As previously noted, the registered traveler record includes one or more database fields, which may include customer provided information, links to payment records, biometric identifiers, as well as additional information. For example, the registered traveler record may include frequent flyer numbers for one or more airlines. The record may further include transaction data. This may be useful, for example, in tracking the flight history of the particular customer. The database record may include account actions and the dates thereof, for example, address changes, comments from the customer or operator of the registered traveler database, or other pertinent notes. Once the customer has become a registered traveler, the way the customer interfaces with the airlines, and the customer's passage through the various airports, may be effected as described in conjunction with the examples of FIGS. 2A-2D.

Alternative embodiments of methods according to the present invention will be described with reference to FIGS. 2A-2D. Again, the described methods involve an airline passenger, however, the present invention is not so limited. As shown in FIG. 2A, a traveler purchases an airline ticket. This purchase may be made through known procedures such as by logging onto an airline's website, by contacting the airline directly by telephone, by going to or calling a travel agent, or the like. The ticket request requires the agency, website, or airline customer service representative (CSR) to interface with a reservation system shown as the passenger name record (PNR) in FIG. 2A. A record is created of the desired customer's flight, including for example, the date and time of travel, the flight number, the airline, frequent flyer number (if any), and the like. In this embodiment, the airline reservation system interfaces with a registered traveler system to determine if the customer is a registered traveler. In some embodiments, the customer verbally or otherwise indicates to the airline that they are a registered traveler, such as by presenting a registered traveler card.

In one embodiment, the frequent flyer number for the customer associated with the airline on which they are flying is used to interface with the registered traveler system. As shown in FIG. 1B, in some embodiments frequent traveler numbers are maintained in the registered traveler record for each registered traveler customer. In one embodiment, the registered traveler system returns a registered traveler tag to the PNR system in the event the registered traveler system verifies that the customer is a registered traveler. The registered traveler tag may comprise an indicator which uniquely identifies the particular customer as a registered traveler. The registered traveler tag may include, without limitation, a 2D barcode, a magnetic stripe, a string of alphanumeric characters, or the like.

On the date of travel, the customer goes to the airport and proceeds to check in at the ticket counter and/or at a kiosk. At this time, the customer receives a boarding pass, which may be retrieved, for example, by presenting a credit card, registered traveler card, or other piece of identification to the ticket counter or kiosk which in turn prints the boarding pass. The registered traveler then proceeds to the security checkpoint with the boarding pass. In a preferred embodiment, the boarding pass has the registered traveler (RT) tag on the boarding pass. The customer has received this boarding pass with the RT tag, at least in part, because of the prior interface between the registered traveler system and the PNR. The TSA security checkpoint, in a preferred embodiment, has a “fast lane” or a separate lane or section for registered travelers to pass through security. In one embodiment, the boarding pass is presented to the security agent. A biometric is received from the customer using a biometric collection device. The biometric collection device may include, for example, an optical print reader which extracts minutia from a finger or thumbprint of the traveler. Other biometric collections devices may be used for the retrieval of desired biometric information from the customer.

The information retrieved from the boarding pass, and more specifically, the information retrieved from the RT tag on the boarding pass, along with the biometric data is transmitted to the RT system. In one embodiment, the biometric collection device is coupled to the RT system through a network. The network may include a secure communications network coupling the two systems. The RT system then operates to determine whether or not the customer whose data they have just received is indeed a registered traveler. This process first includes a one-to-one match using the RT identifier. For example, the RT system maintains database records for each registered traveler which includes an RT identifier. The identifier, which may be an alphanumeric string of characters in some embodiments, is transmitted from the security checkpoint to the RT system and used to locate the registered traveler record associated with that identifier. In this manner, a one-to-one search is performed, to quickly locate the appropriate record. Then, the received biometric data is compared with the biometric data stored in the database record for that registered traveler. This comparison may involve, for example, the comparison of a collected fingerprint or the minutia of a collected fingerprint, with the fingerprint stored in the registered traveler record. In the event a match exists, the RT system returns an authorization or “OK” to the TSA security checkpoint. The customer, who has now been verified to be a registered traveler, proceeds through security and continues to the gate where they may board the aircraft according to standard boarding procedures. In the event the biometric comparison is not a match, a rejection or red flag is sent to the security checkpoint. At this point, appropriate action may be undertaken. For example, the customer may be directed to pass through the regular security lines. Alternatively, the customer may be detained for questioning, a security search, or further investigation to determine if the customer is on a security watch list.

In an alternative embodiment, the biometric readers are placed at alternative locations than described above. For example, a biometric reader may be placed at the ticket counter or kiosk, with the registered traveler status of the customer being verified before issuance of the board pass containing the RT tag. The customer then passes through security, but has their registered traveler status re-verified at the gate prior to boarding. This may occur, for example, by collecting biometric data, transmitting the biometric data and RT identifier to the RT system and requesting verification of the registered traveler status. In this manner, prior to boarding, the customer is again verified that they are indeed a registered traveler. Alternatively, as described above, a single biometric reader is placed at the security checkpoint. In this embodiment, the verification of the registered traveler status is determined prior to passing through security after which the customer may board the aircraft based on their having the appropriate boarding pass for the particular flight.

FIG. 2B depicts an alternative embodiment of a method according to the present invention. In this embodiment, a number of the features or procedures are similar to or the same as those described in conjunction with FIG. 2A. In this embodiment, the customer has printed their own boarding pass, such as at home or at work. This may occur, for example, for airlines which allow the user to arrange their own travel via the airline's website and then print the boarding pass appropriate for the scheduled travel. Further, the boarding pass may be printed at a travel agency and presented to the customer. The airline's goal of providing this function includes, for example, the ability for the customer to bypass the ticket counter in the event they are traveling with only carry-on luggage. In this embodiment, however, the customer must again verify that they are indeed a registered traveler in order to take advantage of the “fast lane” at the security counter. To do so, the traveler provides biometric information such as fingerprint data, digital facial image(s), iris scan, or the like. In this embodiment, the biometric reader at the security checkpoint is coupled to the PNR reservation system. The PNR reservation system receives the biometric information and transmits it to the RT system for verification that the biometric information has been provided by a registered traveler. The PNR system also may transmit other data retrieved from the customer's boarding pass, such as a customer name, frequent flyer number, registered traveler identifier, or the like. In one embodiment, the RT system uses this additional information to locate the corresponding registered traveler record. The RT system then compares the biometric provided by the PNR, or directly provided by the TSA security checkpoint, with the stored biometric for that record.

The verification or rejection of the registered traveler status of the customer is transferred back to the PNR system and made available at the security checkpoint, and/or is transferred directly to the TSA security checkpoint. In this manner, if verification has occurred, the customer may proceed through the fast lane. In another embodiment, the return message from the RT system is sent directly to the appropriate security checkpoint. The RT system may be informed of the desired security checkpoint by the PNR system, when the PNR system requests verification of the customer's registered traveler status. In some embodiments, a second biometric reader is provided at the gate. In this manner, the identity of the customer is verified with the RT system prior to allowing the customer to board the aircraft. In an alternative embodiment, the biometric reader at the gate is optional, and the traveler's identity is not verified again prior to boarding for cases in which the identity of the traveler has been previously verified at the security checkpoint.

FIGS. 2C-2F depict alternative embodiments of methods of the present invention. These embodiments vary slightly with respect to the time and location at which the registered traveler identity is verified, the boarding passes are printed, and the like. For example, using the passenger name record (PNR) as an indexing function for a registered traveler identifier (RTIN), the PNR, in some embodiments, houses the RT identification number or identifier. The RTIN prints or is able to be printed on the boarding pass when the customer receives it. The RTIN may, for example, be encoded on a 2D barcode. The PNR also may use an already existing unique traveler number (e.g., an airline frequent flyer number) as the identification on the boarding pass. In some embodiments, an ISO 8583 message format is used at a security gate to send the RTIN and a biometric extracted identifier in an optical field of the ISO 8583 message to a central authentication database. In one embodiment, the RT system uses the RTIN to find the individual in question, and then the biometric identifier would be verified against a previously enrolled template to determine if they are the same individual. The central authentication server would determine a match while the database also does a search on the RTIN to determine if that number is in good standing. The central authentication server returns a message which would let the individual pass through the registered traveler line or “fast lane” or be declined with further action required or not required. For example, the passenger may be declined access to the RT line in the event they have an expired registered traveler identifier or registered traveler card, or if the individual is on one or more watch lists, or the like.

FIGS. 2C and 2D involve a customer who is using a ticket purchased in a manner similar to that described in conjunction with FIG. 2A. As shown in FIG. 2D, the traveler's biometric is verified at the security checkpoint, but not at the gate. In FIG. 2C, the traveler's biometric is verified at the security checkpoint and/or ticket counter, and also at the gate. In this manner, the customer boarding the aircraft is confirmed to be the same as the registered traveler. As a result, a traveler's attempts to switch boarding passes with another passenger after they have passed through security are reduced or eliminated.

FIGS. 2E and 2F involve a customer who is using a ticket purchased in a manner similar to that described in conjunction with FIG. 2B. Again, one of the differences between the two embodiments involves the location(s) at which the customer identity is verified through, in some cases, the collection and verification of biometric data.

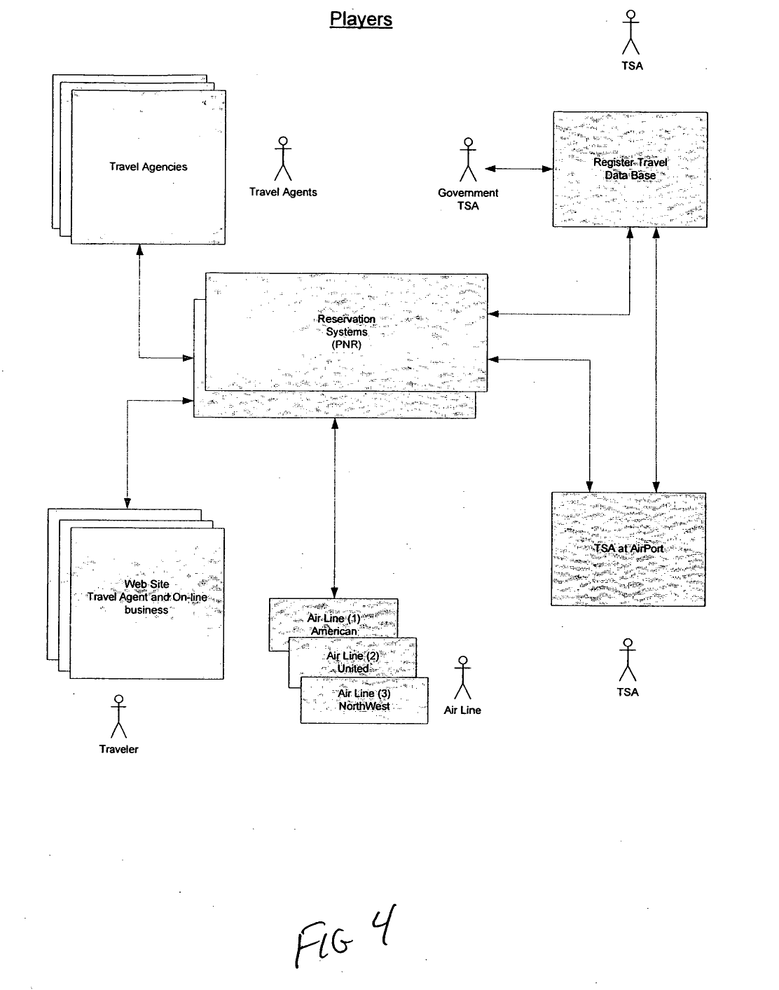

FIG. 3 depicts a registered traveler (RT) system 300 according to an embodiment of the present invention. As shown in the upper portion of FIG. 3, the registered traveler system 300 may allow customer access, government access, and airport access. Government access may be desirable through a firewall while, in one embodiment, airport access and government access occurs through a lease line. FIG. 3 depicts various system components of system 300 according to a particular embodiment of the present invention. One advantage of the present invention is the use of a centralized database for all registered travelers. In this manner, the databases are not limited to a particular airport or a particular airline. Instead, the registered traveler database is centrally maintained and accessible by all airlines and/or airports and/or desired government agencies. This provides improved access to relevant information as well as consistent standards and features. Further, the FBI, DHS, or the like may request searches on the database to determine if a person on a watch list, a terrorist, a criminal, or the like, has attempted to obtain registered traveler status.

As shown in FIG. 3, system 300 includes a primary application and a backup application. This may be desired, for example, in the event problems occurs with the primary application. Real time or near real time verification of registered traveler information is desirable so that customers obtain some benefit from being a registered traveler. In particular, one of the benefits is the increased speed at which the travelers may pass through the airport and, in particular, through the airport security checkpoints. In one embodiment, system 300 includes a development and quality control system 320 which substantially mirrors the primary system 300. This may be useful, for example, as a backup data center. This also may be useful for the testing and implementation of new features prior to roll-out to the primary system 300. It will be appreciated by those skilled in the art that the various subcomponents, including webs, servers, switches, applications, controllers, database clusters, and the like, may vary from those depicted within the scope of the present invention.

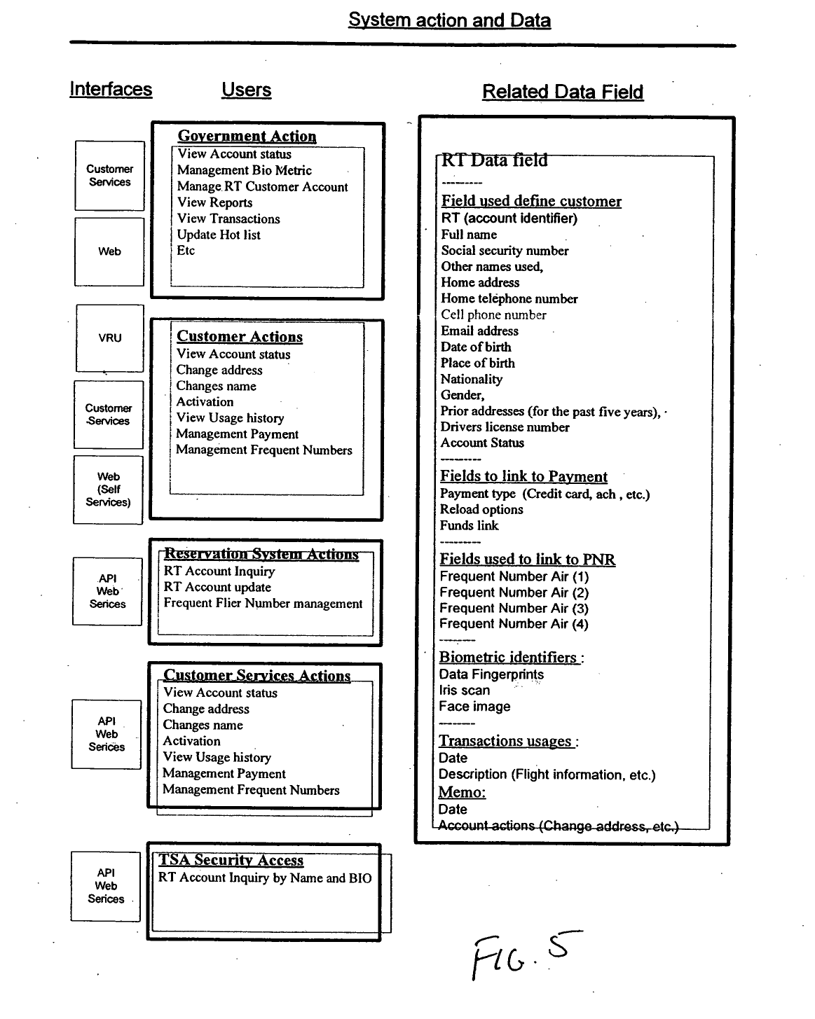

Turning now to FIGS. 4 and 5, the interface between the various participants in the systems and methods of the present invention will be further described. As shown in FIG. 4, a traveler may interface with various travel agents, websites, or directly with the airlines. The airlines and agents, in turn, interface with the Passenger Name Record (PNR) reservation systems. The reservation system used by one or more airlines, in turn, interfaces with TSA checkpoints at the various airports, as well as the registered traveler database. As described in conjunction with FIGS. 2A-2D, some embodiments require the TSA checkpoint interface directly with the reservation system and/or the RT system. In other embodiments, the airline system interfaces with the RT system. In still other embodiments, all three systems are interconnected so that the customer may be verified as a registered traveler at multiple locations.

As shown in FIG. 5, the various users may interface with other components of system 300 using different interfaces, and may have access to different information. The related data field portion of FIG. 5 is similar to or the same as shown in FIG. 1B, and may include additional or reduced levels of information. Further, as shown in FIG. 5, the customer actions for a particular traveler may include those listed, such as viewing their account, changing their name and address, updating payment information (e.g., changing credit cards) and the like. The customer interfaces with the registered traveler system through a voice recognition unit (VRU), through a customer service agent, or through an internet site such as a password-protected website. The government, such as the FBI and other intelligence agencies, may view registered traveler data, and may request searches of the data base as desired. Further, reports may be generated by the registered traveler system for receipt or viewing by the government agencies. This may be useful, for example, if the security or intelligence agencies want to monitor frequent travelers to countries which may be known or suspected to have an increased number of terrorists or terrorist activities. The government interface through the RT system may include, for example, web based interfaces and customer service interfaces. The airline reservation system and the TSA security access may also interface with the RT system as described above. This interface may occur through network connections, such as API web services.

The invention has now been described in detail. However, it will be appreciated that the invention may be carried out in ways other than those illustrated in the aforesaid discussion, and that certain changes and modifications which may be practiced within the scope of the appended claims. Accordingly, the scope of this invention is not to be limited by those specific examples, but rather is to be accorded the full scope represented in the following claims.

What is claimed is:

1. A method of registering travelers, the method comprising:
receiving a customer data set with a controller;
receiving a customer biometric with the controller;
transmitting at least a portion of the data set to a remote system;
receiving a response from the remote system; and
creating a registered traveler record using the customer data set and the customer biometric.

2. The method as in claim 1 wherein the customer data set comprises at least a customer name, a customer address, and a customer identification number.

3. The method as in claim 2 wherein the customer identification number comprises a social security number.

4. The method as in claim 2 wherein the customer data set comprises a frequent flyer number associated with the customer name.

5. The method as in claim 1 wherein the customer data set comprises a payment record.

6. The method as in claim 1 wherein the customer biometric comprises an iris scan.

7. The method as in claim 1 wherein the customer biometric comprises at least one image of a customer face.

8. The method as in claim 1 wherein the customer biometric comprises a customer fingerprint set.

9. The method as in claim 8 wherein the customer fingerprint set comprises a ten print set.

10. The method as in claim 1 wherein the remote system is a background check system.

11. The method as in claim 1 wherein the registered traveler record comprises a registered traveler identifier.

12. A method of confirming a traveler identity, the method comprising:
creating a registered traveler record for a traveler, the record comprising a registered traveler identifier and a registered traveler biometric;
storing the registered traveler record in a database;
receiving a verification request from a remote computer-based system, the verification request comprising a traveler identifier and a received biometric;
retrieving the registered traveler record;
comparing the received biometric with the registered traveler biometric; and
returning an authorization if the received biometric matches the registered traveler biometric.

13. The method as in claim 12 wherein the database comprises a plurality of registered traveler records for a plurality of registered travelers.

14. The method as in claim 12 wherein the remote computer-based system comprises an airport security system.

15. The method as in claim 12 wherein the remote computer-based system comprises an airline reservation system.

16. The method as in claim 12 wherein retrieving the registered traveler record is based on the received traveler identifier.

17. The method as in claim 12 wherein the registered traveler biometric comprises a traveler fingerprint, and the received biometric comprises a fingerprint.

18. The method as in claim 12 wherein the registered traveler biometric comprises a traveler fingerprint, and the received biometric comprises at least a portion of a fingerprint.

19. The method as in claim 12 wherein the registered traveler biometric comprises a traveler iris scan, and the received biometric comprises an iris scan.

20. The method as in claim 12 further comprising returning a message if the received biometric does not match the registered traveler biometric.

21. The method as in claim 20 wherein the message comprises a rejection notice.

22. The method as in claim 20 wherein the message comprises a detention notice.

23. The method as in claim 12 wherein receiving the verification request comprises receiving an ISO 8583 formatted message.

24. The method as in claim 12 wherein a controller coupled to the database compares the received biometric and the registered traveler biometric.

25. The method as in claim 12 further comprising comparing the received traveler identifier with a watch list.

26. A traveler registration system, comprising:
a database comprising a plurality of registered traveler records, each of the registered traveler records comprising an identifier and a biometric; and
a controller coupled to the database, the controller adapted to:
receive a traveler verification request from a remote requester, the verification request comprising a received identifier and a received biometric;
retrieve one of the registered traveler records based at least in part on the received identifier;
compare the biometric with the received biometric; and
return a message to the remote requester, the message having a result of the biometric comparison.

27. The registration system as in claim 26 wherein the remote requester comprises a computer-based airport security system.

28. The registration system as in claim 26 wherein the remote requester comprises an airline reservation system.

29. The registration system as in claim 26 further comprising an interface between the controller and a remote network, the remote network adapted to perform a background check on the biometric.
